(19) United States
(12) Patent Application Publication
(10) Pub. No.: US 2017/0267492 A1
(43) Pub. Date: Sep. 21, 2017

(54) SELF-POWERED ELEVATOR CAR

(71) Applicant: Otis Elevator Company, Farmington, CT (US)

(72) Inventors: Amir Lotfi, South Windsor, CT (US); Felix Benjamin Donath, Berlin (DE)

(21) Appl. No.: 15/070,300

(22) Filed: Mar. 15, 2016

(51) Int. Cl. B66B 11/02; B66B 11/04; B66B 9/00

(52) U.S. Cl. CPC B66B 11/0226; B66B 9/00; B66B 11/04

(57) ABSTRACT

An elevator car is constructed and arranged to move along a hoistway defined by a stationary structure. The elevator car includes a cabin and a component constructed and arranged to be in motion with respect to the cabin. A generator is carried by the cabin and is mechanically coupled to the component for driving the generator as the elevator car moves along the hoistway. An energy storage device of the elevator car is carried by the cabin and is configured to be charged by the generator. An electrical load of the elevator car is powered by at least one of the energy storage device and the generator.

### BACKGROUND

The present disclosure relates to elevator systems, and more particularly to a self-powered elevator car of the elevator system.

Power and communication signals for traditional elevator systems are transferred via a traveling cable to an elevator car of the elevator system. More recent advancements in wireless communications enable the transfer of signals to and from the elevator car without the use of a traveling cable. Unfortunately, to energize components at or carried by the elevator car, a traveling power cable is still traditionally used. The cost of such traveling cables becomes more significant as structures or building become higher. Alternative approaches for powering an elevator car are desirable.

### SUMMARY

An elevator car constructed and arranged to move along a hoistway defined by a stationary structure, and according to one, non-limiting, embodiment of the present disclosure includes a cabin; a component constructed and arranged to be in motion with respect to the cabin; a generator carried by the cabin and mechanically coupled to the component for driving the generator as the elevator car moves along the hoistway; an energy storage device carried by the cabin and configured to be charged by the generator; and an electrical load powered by at least one of the energy storage device and the generator.

Additionally to the foregoing embodiment, the elevator car is cable-less.

In the alternative or additionally thereto, in the foregoing embodiment, the generator is configured to be activated during regenerative runs.

In the alternative or additionally thereto, in the foregoing embodiment, the generator is configured to be activated during e-stops.

In the alternative or additionally thereto, in the foregoing embodiment, the component is a cable sheave constructed and arranged to rotate as the elevator car moves along the hoistway, and wherein the generator is rotationally coupled to the cable sheave.

In the alternative or additionally thereto, in the foregoing embodiment, the generator is configured to be activated during regenerative runs and deactivated during acceleration periods.

In the alternative or additionally thereto, in the foregoing embodiment, the generator is configured to be activated during load transfers.

In the alternative or additionally thereto, in the foregoing embodiment, the generator is configured to be activated during idle conditions.

In the alternative or additionally thereto, in the foregoing embodiment, the cable sheave is a cabin-top sheave.

In the alternative or additionally thereto, in the foregoing embodiment, the cable sheave is an under-slung cable sheave.

In the alternative or additionally thereto, in the foregoing embodiment, the component is a guide roller rotationally engaged to the cabin and constructed and arranged to roll upon the stationary structure, and wherein the generator is coupled to the guide roller.

In the alternative or additionally thereto, in the foregoing embodiment, the energy storage device is a battery.

An elevator system according to another, non-limiting, embodiment includes a stationary structure defining a hoistway; a self-powered elevator car including a cabin, a generator carried by the cabin and mechanically coupled to the stationary structure for driving the generator as the self-powered elevator car moves along the hoistway, an energy storage device carried by the cabin and configured to be charged by the generator, and an electrical load powered by at least one of the energy storage device and the generator; a drive device configured to move the self-powered elevator car along the hoistway, the drive device including a controller supported by the stationary structure; and a wireless communication system configured to communicate between the elevator car and the controller.

Additionally to the foregoing embodiment, the elevator system is belt-less.

In the alternative or additionally thereto, in the foregoing embodiment, the energy storage device is a battery.

In the alternative or additionally thereto, in the foregoing embodiment, the energy storage device is a capacitor.

In the alternative or additionally thereto, in the foregoing embodiment, the electrical load is at least one of a ventilation unit, a lighting system, a control unit, a communication unit, a door drive system, and a braking system.

In the alternative or additionally thereto, in the foregoing embodiment, the drive device includes a sheave rotationally mounted to the cabin and a belt looped about the sheave for propelling the cabin, and the generator is coupled to the sheave.

A method of powering an elevator car according to another, non-limiting, embodiment includes moving the elevator car along a hoistway; driving a generator carried by a cabin of the elevator car via displacement between the moving elevator car and a stationary structure defining the hoistway; charging an energy storage device carried by the cabin via the generator when activated; powering an electrical load via the energy storage device; activating the generator during regenerative runs; and deactivating the generator during acceleration periods.

Additionally to the foregoing embodiment, the method includes activating the generator during e-stops.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of an elevator system according to one, non-limiting, embodiment of the present disclosure;

FIG. 2 is a schematic of a second embodiment of an elevator car of the elevator system; and

FIG. 3 is a schematic of a third embodiment of an elevator car of the elevator system.

### DETAILED DESCRIPTION

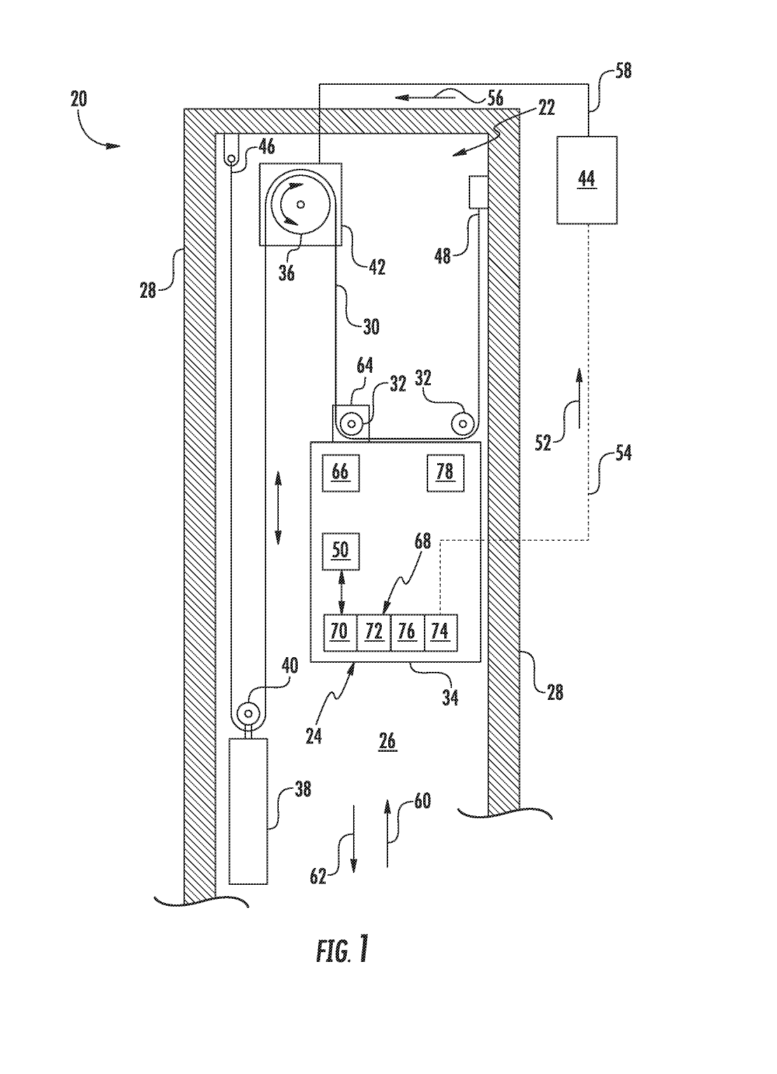

Referring to FIG. 1, an elevator system 20 of the present disclosure is illustrated, and may include a drive device 22 configured to move an elevator car 24 of the drive device along a hoistway 26 defined by a stationary structure 28. The drive device 22 may include a cable 30, at least one sheave 32 rotationally mounted to a cabin 34 of the elevator car 24, a rotationally driven sheave 36 fixed to the stationary structure 28, a counter weight 38, a sheave or pulley 40 rotationally engaged to the counterweight 38, an electric motor 42 rotationally coupled to the driven sheave 36, and a controller 44 configured to control at least the actuation of the electric motor 42. The cable 30 is generally routed through the sheaves 32, 36, 40 and may include opposite ends 46, 48 fixedly engaged to the stationary structure 28. The stationary structure 28 may, for example, be a building having multiple floors (not shown) with the elevator system 20 being constructed and arranged to controllably stop at different floors as directed by passengers that may travel within the cabin 34. It is further contemplated and understood that the term ‘cable’ may include ropes and/or belts that may be used or applied interchangeably.

In operation, passengers who enter the cabin 34 may choose a floor as a destination by entering the desired destination into a user control panel 50 of the elevator car 24. The desired destination may be sent as a command signal (see arrow 52) to the controller 44 over a pathway 54 that may be a wireless pathway. The controller 44 may then send a drive signal (see arrow 56) over a pathway 58 to the motor 42 thereby energizing and directing operation of the motor (e.g., rotational direction, etc.). If the desired destination causes the elevator car 24 to move in an upward direction (see arrow 60), the orientation of the cable 30 and sheaves 32, 36, 40 causes the counterweight 38 to move in a downward direction (see arrow 62). If the desired destination causes the elevator car 24 to move in the downward direction 62, the counterweight 38 will move in the upward direction 60. The counterweight 38 may generally weigh about the same as the elevator car 24 when at about fifty percent capacity, and thus reduces the work output requirements of the drive device 22. It is further contemplated and understood that the wireless command signal 52 may be any other variety of signals includes general information of the status of the elevator car 24 and/or components of the elevator car, and and/or general communications depending upon the type or configuration of the elevator system 20.

Although the elevator system 20 may include the cable or belt 30, the system may not include a traditional, traveling, electric power cable extending between the elevator car 24 and the stationary structure 28 and/or controller 44. Similarly, the elevator system 20 may not include a traditional, traveling, communication cable (i.e., hardwired pathway) extending between the elevator car 24 and the controller 44. As such, the elevator car 24 may be a self-powered elevator car, and may include the cable sheave 32 that may be rotationally mounted to the top of the cabin 34, a generator 64, an energy storage device 66, and a controller 68. The controller 68 may include a computer-based processor 70 (e.g., microprocessor) and a computer readable and writeable storage medium 72, a wireless communication unit 74, and an energy management system 76 that may be software based. As one, non-limiting, example, the generator 64, which is carried by the cabin 34, may be a permanent magnet generator rotationally coupled to the cabin sheave 32. As the cabin sheave 32 rotates when the cabin 34 is moving in the up and down directions 60, 62, the sheave 32 drives the generator 64. It is further contemplated and understood that the generator 64 while being carried by the cabin 34 may be driven by any variety of components that may generally move with respect to the stationary structure 28 and/or with respect to the cabin 34 as the cabin moves within the hoistway 26.

As directed by the energy management system 76, the generator 64 while being driven by, for example, the cabin sheave 32 may be activated or deactivate. When activated, the generator 64 may be configured to recharge the energy storage device 66 and/or provide electric power to other electrical loads 78 of the elevator car 24. Examples of the energy storage device 66 may include a battery, a capacitor (e.g., super capacitor) and others. Examples of electrical loads 78 may include the controller 68 and/or aspects of the controller (e.g., wireless communication unit 74), a ventilation unit, a lighting system, a door drive system, a braking system and other elevator car loads known to those skilled in the art. In operation, the generator 64 may be activated only in regenerative runs (e.g., an empty car moving up or heavy car moving down) or after acceleration time to minimize the impact on drive size. The activated generator 64 may be used as an alternative or in combination to known regenerated energy concepts for elevators (i.e., Regen drives) where the generated energy may be directed to the car instead of the grid. Regen drives are known in the art of elevators, and are adapted to direct regenerated energy back to the building electrical grid whenever the heavy side of the elevator is going down. Alternatively or in addition to, the generator 64 may be activated during e-stops (i.e., emergency stops) of the elevator car 24 to reduce belt 30 slip, may be activated during load transfer to increase damping at landings (i.e., floor destinations), and/or may be activated during idle condition to prevent/reduce belt slip/creep. That is, engaging a clutch of the generator 64, and/or the friction caused by internal gears may reduce belt creep.

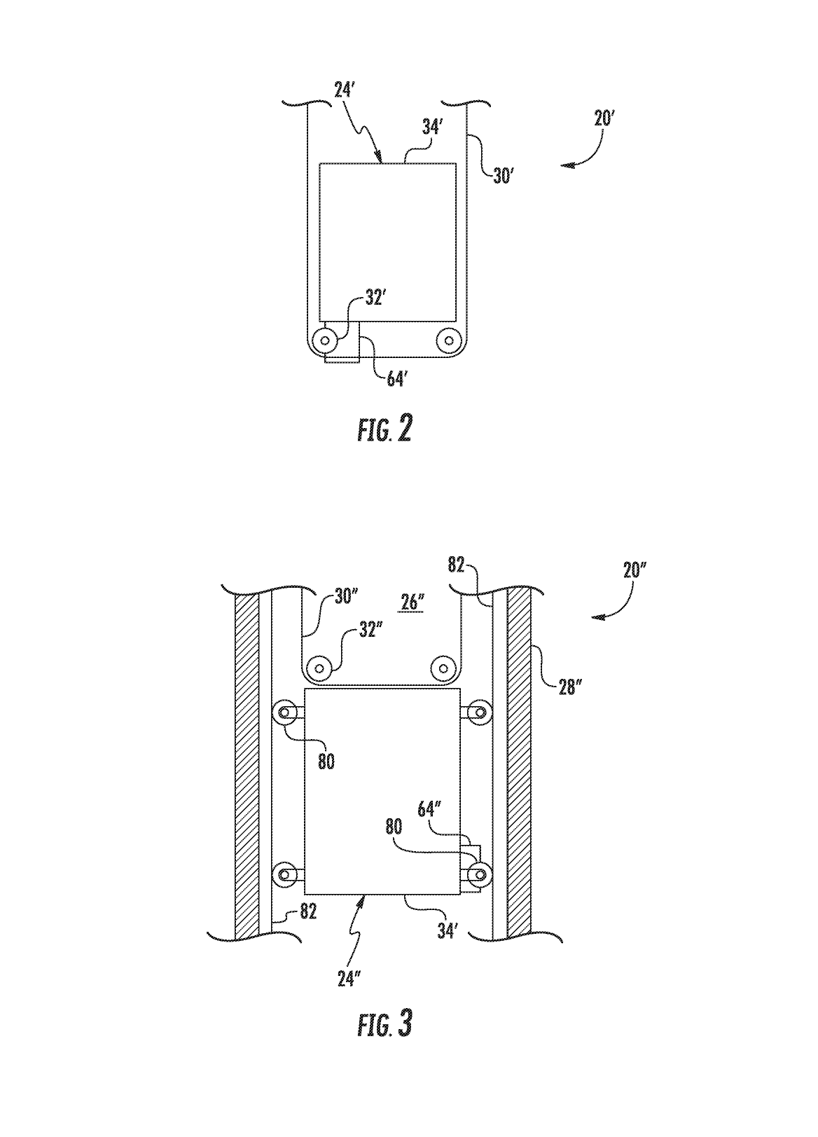

Referring to FIG. 2, a second embodiment of an elevator system is illustrated wherein like elements to the first embodiment have like identifying numerals except with the addition of a prime suffix. An elevator system 20′ includes an under-slung sheave orientation where at least one cabin sheave 32′ is mounted to a bottom or underside of a cabin 34′. A generator 64′ may be carried by the underside of the cabin 34′ and driven by the sheave 32′.

Referring to FIG. 3, a third embodiment of an elevator system is illustrated wherein like elements to the first embodiment have like identifying numerals except with the addition of a double prime suffix. An elevator system 20″ includes an elevator car 24″ including a plurality of guide rollers 80 as another example of a component capable of being coupled to and driving a generator 64″. The rollers 80 are rotationally engaged to a cabin 34″ of the elevator car 24″ and are constructed and arranged to ride upon at least one rail 82 (i.e., two illustrated on either side of a hoistway 26″) rigidly fixed to a stationary structure 28″. It is further contemplated and understood that the elevator system may be a rope-less elevator system (i.e., also known as a self-propelled elevator system) generally known in the art. In this example, the rope-less elevator system not only has no traveling power cables but has no ropes or belts used to propel the elevator car.

Benefits and advantages of the present disclosure include an elimination of traveling cables thereby lowering cost, installation time and moving mass from more traditional elevator systems. Such reduction in costs is enhanced when considering mega highrise building systems. Other benefits include regeneration of energy used within the elevator rather than a public power grid, lower bounce at landings, and lower rope and/or belt slip during, for example, e-stops.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. An elevator car constructed and arranged to move along a hoistway defined by a stationary structure, the elevator car comprising:
a cabin;
a component constructed and arranged to be in motion with respect to the cabin;
a generator carried by the cabin and mechanically coupled to the component for driving the generator as the elevator car moves along the hoistway;
an energy storage device carried by the cabin and configured to be charged by the generator; and
an electrical load powered by at least one of the energy storage device and the generator.

2. The elevator car set forth in claim 1, wherein the elevator car is cable-less.

3. The elevator car set forth in claim 1, wherein the generator is configured to be activated during regenerative runs.

4. The elevator car set forth in claim 3, wherein the generator is configured to be activated during e-stops.

5. The elevator car set forth in claim 1, wherein the component is a cable sheave constructed and arranged to rotate as the elevator car moves along the hoistway, and wherein the generator is rotationally coupled to the cable sheave.

6. The elevator car set forth in claim 5, wherein the generator is configured to be activated during regenerative runs and deactivated during acceleration periods.

7. The elevator car set forth in claim 6, wherein the generator is configured to be activated during load transfers.

8. The elevator car set forth in claim 6, wherein the generator is configured to be activated during idle conditions.

9. The elevator car set forth in claim 5, wherein the cable sheave is a cabin-top sheave.

10. The elevator car set forth in claim 5, wherein the cable sheave is an under-slung cable sheave.

11. The elevator car set forth in claim 1, wherein the component is a guide roller rotationally engaged to the cabin and constructed and arranged to roll upon the stationary structure, and wherein the generator is coupled to the guide roller.

12. The elevator car set forth in claim 1, wherein the energy storage device is a battery.

13. An elevator system comprising:
a stationary structure defining a hoistway;
a self-powered elevator car including a cabin, a generator carried by the cabin and mechanically coupled to the stationary structure for driving the generator as the self-powered elevator car moves along the hoistway, an energy storage device carried by the cabin and configured to be charged by the generator, and an electrical load powered by at least one of the energy storage device and the generator;
a drive device configured to move the self-powered elevator car along the hoistway, the drive device including a controller supported by the stationary structure; and
a wireless communication system configured to communicate between the elevator car and the controller.

14. The elevator system set forth in claim 13, wherein the elevator system is belt-less.

15. The elevator system set forth in claim 13, wherein the energy storage device is a battery.

16. The elevator system set forth in claim 13, wherein the energy storage device is a capacitor.

17. The elevator system set forth in claim 16, wherein the electrical load is at least one of a ventilation unit, a lighting system, a control unit, a communication unit, a door drive system, and a braking system.

18. The elevator system set forth in claim 13, wherein the drive device includes a sheave rotationally mounted to the cabin and a belt looped about the sheave for propelling the cabin, and the generator is coupled to the sheave.

19. A method of powering an elevator car comprising:
moving the elevator car along a hoistway;
driving a generator carried by a cabin of the elevator car via displacement between the moving elevator car and a stationary structure defining the hoistway;
charging an energy storage device carried by the cabin via the generator when activated;
powering an electrical load via the energy storage device;
activating the generator during regenerative runs; and
deactivating the generator during acceleration periods.

20. The method set forth in claim 19 further comprising:
activating the generator during e-stops.
